(19) United States
(12) Patent Application Publication
(10) Pub. No.: US 2024/0397524 A1
(43) Pub. Date: Nov. 28, 2024

(54) Terminal Device, Network Node and Methods Performed therein for Handling Downlink Control Information

(71) Applicant: Telefonaktiebolaget LM Ericsson (publ), Stockholm (SE)

(72) Inventors: Liping Zhang, Beijing (CN); Gerardo Agni Medina Acosta, Märsta (SE); Ola Lundqvist, Karlstad (SE)

(21) Appl. No.: 18/695,895

(22) PCT Filed: Sep. 30, 2022
(86) PCT No.: PCT/SE2022/050874

§ 371 Date: Mar. 27, 2024

(30) Foreign Application Priority Data
Oct. 1, 2021 (WO) PCT/CN2021/122492

(51) Int. Cl. H04W 72/232; H04L 1/1812

(52) U.S. Cl. CPC H04W 72/232; H04L 1/1812

(57) ABSTRACT

Various embodiments of the present disclosure provide a method for handling DCI. The method which may be performed by a terminal device comprises receiving DCI from a network node and determining one or more bits in the DCI. The one or more bits in the DCI are determined to be available for forming a joint encoding DCI field indicating both physical downlink shared channel. PDSCH, scheduling delay and hybrid automatic repeat request-acknowledgement, HARQ-ACK, delay, based at least in part on a 14 hybrid automatic repeat request, HARQ, processes feature being configured. The one or more bits are associated with only one DCI field existing prior to standardization support of the 14 HARQ processes feature in downlink, DL.

### TECHNICAL FIELD

The present disclosure generally relates to communication networks, and more specifically, to a terminal device, a network node, and methods performed therein for handling downlink control information (DCI). Furthermore, a computer-readable medium is also provided herein.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the rapid development of networking and communication technologies, wireless communication networks such as long-term evolution (LTE)/fourth generation (4G) network and new radio (NR)/fifth generation (5G) network are expected to achieve high traffic capacity and end-user data rate with lower latency. In order to meet the diverse requirements of services across a wide variety of industries, the 3rd generation partnership project (3GPP) is developing various networking technologies (e.g., narrow band-Internet of things (NB-IoT), etc.) and communication types (e.g., machine-type communication (MTC), etc.). Some enhancements for NB-IoT and LTE-MTC are agreed by 3GPP in Release-17 (Rel-17), for example, specifying for LTE-MTC the introduction of 14 hybrid automatic repeat request (HARQ) processes in downlink (DL).

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Various embodiments of the present disclosure propose a solution for DCI design, which can provide different DCI design strategies to support the introduction of 14 HARQ processes accounting for joint encoding of the HARQ-ACK delay and PDSCH scheduling delay.

According to a first aspect of the present disclosure, there is provided a method performed by a terminal device (e.g., a user equipment (UE) such as LTE-MTC UE). The method comprises receiving DCI from a network node. In accordance with an exemplary embodiment, the method further comprises determining one or more bits in the DCI available for forming a joint encoding DCI field indicating both PDSCH scheduling delay and HARQ-ACK delay, based at least in part on a 14 HARQ processes feature being configured. In an embodiment, the one or more bits are associated to only one DCI field existing prior to the standardization support of 14 HARQ processes feature in DL (e.g., for LTE-MTC UEs).

In accordance with an exemplary embodiment, the one or more bits in the DCI may comprise:
3 bits from a HARQ-ACK delay field (in an embodiment, when the 3 bits become available for the joint encoding of the PDSCH scheduling delay and the HARQ-ACK delay, the HARQ-ACK delay field may be disabled, e.g., the HARQ-ACK delay field may be set to be a 0-bit field and considered as inexistent meanwhile).

In accordance with an exemplary embodiment, when a total number of the one or more bits in the DCI is less than a number of bits required to jointly indicate the PDSCH scheduling delay and the HARQ-ACK delay, the joint encoding DCI field may include the one or more other bits in addition to the one or more bits in the DCI.

In accordance with an exemplary embodiment, the one or more other bits may comprise 4 bits. For example, 4 brand new bits may be added into the joint encoding DCI field, together with 3 bits from existing DCI fields (e.g., 3 bits from the HARQ-ACK delay field), so as to build-up the 7-bits based joint-encoding solution.

In accordance with an exemplary embodiment, the one or more other bits may comprise 2 bits. For example, 2 brand new bits may be added into the joint encoding DCI field, together with 3 bits from existing DCI fields (e.g., 3 bits from the HARQ-ACK delay field), so as to build-up the 5-bits based joint-encoding solution.

In accordance with an exemplary embodiment, the terminal device is a long term evolution-machine type communication, LTE-MTC, user equipment, UE.

According to a second aspect of the present disclosure, there is provided an apparatus which may be implemented as a terminal device. The apparatus comprises one or more processors and one or more memories comprising computer program codes. The one or more memories and the computer program codes are configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided a method performed by a network node such as a base station. The method comprises determining one or more bits in DCI available for forming a joint encoding DCI field indicating both PDSCH scheduling delay and HARQ-ACK delay, based at least in part on a 14 HARQ processes feature being configured. In an embodiment, the one or more bits are associated to only one DCI field existing prior to standardization support of 14 HARQ processes feature in DL (e.g., for LTE-MTC UEs). In accordance with an exemplary embodiment, the method further comprises transmitting the DCI to the terminal device.

In accordance with various exemplary embodiments, the DCI transmitted by the network node according to the fourth aspect of the present disclosure may correspond to the DCI received by the terminal device according to the first aspect of the present disclosure. Thus, the DCI according to the first and fourth aspects of the present disclosure may have the same or similar contents and/or feature elements. Correspondingly, the one or more bits in the DCI and optionally the one or more other bits included in the joint encoding DCI field according to the first and fourth aspects of the present disclosure may have the same or similar contents and/or feature elements and may be configured in a same or similar manner.

According to a fifth aspect of the present disclosure, there is provided an apparatus which may be implemented as a network node. The apparatus comprises one or more processors and one or more memories comprising computer program codes. The one or more memories and the computer program codes are configured to, with the one or more processors, cause the apparatus at least to perform any step of the method according to the fourth aspect of the present disclosure.

According to a sixth aspect of the present disclosure, there is provided a computer-readable medium having computer program codes embodied thereon which, when executed on a computer, cause the computer to perform any step of the method according to the fourth aspect of the present disclosure.

According to various exemplary embodiments, a variety of DCI design strategies may be provided for introducing 14 HARQ processes accounting for the joint encoding of the HARQ-ACK delay and PDSCH scheduling delay. The DCI design strategies may consider various factors, e.g., the number of DCI bits required to be increased, backward compatibility, and scheduling flexibility with and without involving radio resource control (RRC) signaling, so as to improve transmission efficiency and resource utilization.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIGS. 1A-1B are diagrams illustrating examples of usage of 14 HARQ processes according to some embodiments of the present disclosure;

FIG. 2 is a flowchart illustrating a method according to some embodiments of the present disclosure;

FIG. 3 is a flowchart illustrating another method according to some embodiments of the present disclosure;

FIG. 4 is a block diagram illustrating an apparatus according to some embodiments of the present disclosure;

FIG. 5 is a block diagram illustrating another apparatus according to some embodiments of the present disclosure;

FIG. 6 is a block diagram illustrating a further apparatus according to some embodiments of the present disclosure;

FIG. 7 is a block diagram illustrating a telecommunication network connected via an intermediate network to a host computer in accordance with some embodiments of the present disclosure;

FIG. 8 is a block diagram illustrating a host computer communicating via a base station with a UE over a partially wireless connection in accordance with some embodiments of the present disclosure;

FIG. 9 is a flowchart illustrating a method implemented in a communication system, in accordance with an embodiment of the present disclosure;

FIG. 10 is a flowchart illustrating a method implemented in a communication system, in accordance with an embodiment of the present disclosure;

FIG. 11 is a flowchart illustrating a method implemented in a communication system, in accordance with an embodiment of the present disclosure; and

FIG. 12 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Towards the support of 14 HARQ processes in DL, the HARQ-ACK (ACKnowledgement) delay solution may be configured with various alternatives, e.g., per Alt-1 for full flexibility or per Alt-2 for support of legacy delay. For both Alt-1 and Alt-2, it may possible that the physical downlink shared channel (PDSCH) scheduling delay and HARQ-ACK delay may be jointly encoded in a single DCI field. For example, the 14 HARQ processes feature may use different joint-encoding solutions, e.g., solution Alt-1 (i.e., 7-bits based joint-encoding solution which requires 7 bits to indicate both the PDSCH scheduling delay and the HARQ-ACK delay, and solution Alt-2e (i.e., 5-bits based joint-encoding solution which requires 5 bits to indicate both the PDSCH scheduling delay and the HARQ-ACK delay). However, the number of bits required by the joint-encoding solution is a not negligible number of bits. Therefore, it may be desirable to implement the DCI design in particular on how to jointly indicate PDSCH scheduling and HARQ-ACK delay for both Alt-1 and Alt-2 in a more efficient way.

During the RAN plenary meeting #86 of 3GPP, a new Work Item (WI) entitled “Rel-17 enhancements for NB-IoT and LTE-MTC” is agreed, as described in 3GPP RP-193264. One of its objectives consists in specifying for LTE-MTC the introduction of 14 HARQ processes in DL as stated in the Work Item Description (WID):
Support additional PDSCH scheduling delay for introduction of 14-HARQ processes in DL, for HD-FDD Cat M1 UEs. [LTE-MTC]/[RANI]

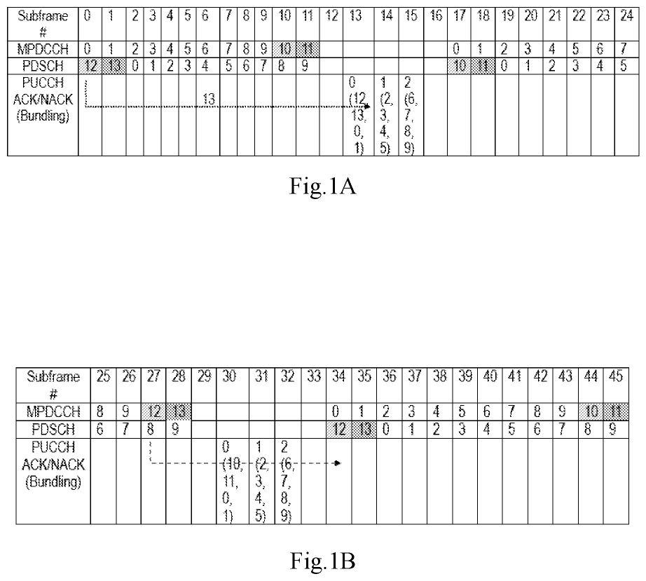

The WID's objective for LTE-MTC targets half duplex-frequency division duplex (HD-FDD) category-M1 (Cat M1) UEs, where a new peak data rate of around 706 Kbps is intended to be achieved through the combined usage of 14 HARQ processes and HARQ-ACK bundling as depicted in FIGS. 1A-1B.

FIGS. 1A-1B are diagrams illustrating examples of usage of 14 HARQ processes according to some embodiments of the present disclosure. Specifically, FIGS. 1A-1B show the combined usage of 14 HARQ processes and HARQ-ACK bundling for a Cat-M1 HD-FDD UE. The time progression of FIG. 1A continues as shown in FIG. 1B, where the dashed arrow (in FIG. 1B) and dotted arrow (in FIG. 1A) illustrate examples of the “Scheduling delay for PDSCH” (encompassing 7 subframes) and “HARQ-ACK delay” (encompassing 13 subframes) respectively.

The following agreements touching upon the PDSCH scheduling delay are reached in 3GPP RANI #104-e:

### Agreement

The PDSCH scheduling delay for the physical uplink control channel (PUCCH) non-repetition case (i.e., PUCCH repetitions=1):
   2 bandwidth-reduced low-complexity or coverage enhanced (BL/CE) DL subframes.
   The PDSCH scheduling delay of 7 is expressed as:
      1 BL/CE DL subframe+1 subframe+ [3 subframes]+1 subframe+1 BL/CE DL subframe.
      1 subframe+ [3 subframes]+1 subframe+2 BL/CE DL subframes.

### Agreement

For the 14 HARQ processes feature, when PUCCH is used with 1 repetition and there is presence of non-BL/CE uplink (UL) subframes (i.e., invalid UL subframes):
   The term surrounded by brackets in Solution 1 is resolved as 3 BL/CE UL subframes.

In 3GPP RANI #105-e, the following agreements are made regarding HARQ-ACK delay solution, with some signaling details and joint encoding being left for further study (FFS):

### Agreement

In Rel-17, for the 14 HARQ process feature the HARQ-ACK delay solution may be supported with multiple solutions: Alt-1 for full flexibility and Alt-2e for support of legacy delay.
Alt-1: The HARQ-ACK delay is determined through an expression consisting of different subframe types (using a similar principle as the PDSCH scheduling delay).
   Without using more than 6 bits.
   FFS: How to minimize the overhead by using joint encoding.
Alt-2: The HARQ-ACK delay is determined following the legacy approach. That is, the “HARQ-ACK delay” is kept expressed in terms of “absolute subframes”.
   The HARQ-ACK delay values and the length of the HARQ-ACK delay set may be based on:
      Alt-2e: “3 bits (same as legacy)”.
      FFS: Whether HARQ delay set is to use range1 or range2.
RRC signaling may be used to configure between Alt-1 and Alt-2e.
FFS: Signaling details.
FFS: Joint encoding.

Afterwards, in 3GPP RANI #106-e, DCI joint encoding of PDSCH scheduling delay and HARQ-ACK delay is further discussed, and the following agreements are made:

### Agreement

Confirm the below working assumption for Alt-2e with following updates.
The PDSCH scheduling delay and HARQ-ACK delay are jointly encoded in a single DCI field:
   The field is 5 bits if Alt-2e is configured.
   FFS: Details of the joint encoding.
   FFS: Legacy DCI fields that may be set to zero bits in length for the jointly encoded solution Alt-2e.

### Agreement

Confirm the below working assumption for Alt-1 with following updates.
The PDSCH scheduling delay and HARQ-ACK delay are jointly encoded in a single DCI field:
   The field is no more than 7 bits if Alt-1 is configured.
   FFS: Details of the joint encoding.
   FFS: Legacy DCI fields that may be set to zero bits in length for the jointly encoded solution Alt-1.
It is noted that Alt-1 expresses the HARQ-ACK delay as: (y) BL/CE DL subframe+1 subframe+ (z) BL/CE UL subframes, where y={0, 1, 2, . . . 11} and z={1, 2, 3}.

### Agreement

For the PDSCH scheduling delay and HARQ-ACK delay jointly encoded in a single DCI field:
   The DCI field uses 7 bits if Alt-1 is configured.

It can be seen that how to implement/describe the states, e.g., table, resulting from the joint encoding solution of Alt-1 is still open for discussion, based on the agreements for the PDSCH scheduling delay, HARQ-ACK delay and the working assumption confirmed for Alt-1.

For both Alt-1 and Alt-2, joint encoding of PDSCH scheduling delay and HARQ-ACK delay may be used since it can provide a bit saving (for Alt-1) and extra-delay values (for Alt-2) with respect to using independent DCI fields for the PDSCH scheduling delay and HARQ-ACK delay.

However, 3GPP has left the door open on the DCI design in particular on how to jointly indicate PDSCH scheduling and HARQ-ACK delay for both Alt-1 and Alt-2. In order to indicate the “PDSCH scheduling delay” and “HARQ-ACK delay”, there may be a need to find out whether some existing DCI fields can be set to zero for the 14 HARQ processes feature as to make use of them for joint-encoding purposes, which may help to do not have to drastically increase the DCI size.

As mentioned previously, one of the solutions for HARQ-ACK delay so-called “Alt-1” may be determined through an expression consisting of different subframe types (using a similar principle as the PDSCH scheduling delay). Alt-1 can handle any percentage of presence of invalid subframes, and the problem is that if Alt-1 is configured, the PDSCH scheduling delay and HARQ-ACK delay jointly encoded in a single DCI field may require 7 bits, which is a high physical layer (L1) signaling overhead. On the other hand, when Alt-2 is configured, the PDSCH scheduling delay and HARQ-ACK delay jointly encoded in a single DCI field may require 5 bits. If all these 7 bits for Alt-1 or 5 bits for Alt-2 are introduced as new DCI bits, this may result in a decoding performance degradation. Thus, how to repurpose already existing DCI bits or whether to introduce new DCI bits may need to be considered with respect to DCI design for e.g. 14 HARQ processes.

Various embodiments of the present disclosure provide a solution of DCI design for 14 HARQ processes in DL e.g., for LTE-MTC UEs. In accordance with an exemplary embodiment, different DCI design strategies may be used to support the introduction of 14 HARQ processes accounting for the joint encoding of the HARQ-ACK delay and PDSCH scheduling delay, including:
Strategy Option 1: when the 14 HARQ processes feature is configured and “HARQ-ACK bundling flag” is set to 1, some legacy DCI fields may be set to zero, e.g., including “Repetition number” and “HARQ-ACK delay” field. These legacy DCI fields together with new added DCI bits may be used for joint encoding.
Strategy Option 2: when the 14 HARQ processes feature is configured, some legacy DCI fields may be set to zero, e.g., including “Repetition number”, “HARQ-ACK delay” and “HARQ-ACK bundling flag” fields. These legacy DCI fields together with one new added DCI bit may be used for joint encoding.
Strategy Option 3: when the 14 HARQ processes feature is configured, only legacy the “HARQ-ACK delay” DCI field may be set to zero. This legacy DCI field together with new added DCI bits may be used for joint encoding.
Strategy Option 4: a “New flag” may be introduced to enable joint encoding of HARQ-ACK delay and PDSCH scheduling delay. When the 14 HARQ processes feature is configured and this “New flag” is set to 1, some legacy DCI fields may be set to zero, e.g., including “Repetition number” and “HARQ-ACK delay” fields. These legacy DCI fields together with the new added DCI bit may be used for joint encoding.

For the joint encoding of the HARQ-ACK delay and PDSCH scheduling delay, the DCI design in accordance with some exemplary embodiments may also consider combining or choosing part from one or several of the above four strategy options.

According to some embodiments, when the 14 HARQ processes feature is configured, one or more existing DCI fields may be set to zero or 0-bits (i.e., such DCI fields may be considered as inexistent meanwhile) in such a way that one or more bits that are associated to the one or more existing DCI fields prior to standardization support of the 14 HARQ processes feature in downlink become available for joint-encoding purposes. If the 14 HARQ processes feature is unconfigured, then the existing DCI fields may include corresponding bits as in legacy.

According to some embodiments, when the 14 HARQ processes feature is configured and flag is set e.g., to 1, one or more existing DCI fields prior to standardization support of the 14 HARQ processes feature in downlink may be set to zero or 0-bits (i.e., such DCI fields may be considered as inexistent meanwhile) in such a way that the one or more bits that are associated to the one or more existing DCI fields become available for joint-encoding purposes. In an embodiment, if the 14 HARQ processes feature is still configured and the flag changes its status (e.g., from 1 to 0), then the existing DCI fields may include corresponding bits as in legacy.

Depending on whether one or more existing DCI fields prior to standardization support of the 14 HARQ processes feature in downlink are set to 0-bits, the bits obtained from the existing DCI fields may be sufficient to build-up the joint-encoding solution (e.g., for the 5-bit based joint encoding solution). In an embodiment, if those bits are not sufficient then the bits from the existing DCI fields may be combined with one or more brand new bits (which may increase the size of DCI Format 6-1A) as to build-up e.g. the 7-bits based joint-encoding solution.

Many advantageous may be achieved by applying the proposed DCI design strategy option(s) for the support of 14 HARQ processes accounting for the joint encoding of the HARQ-ACK delay and PDSCH scheduling delay, e.g., including but not limited to:
Strategy Option 1: This solution may be intended to offer scheduling flexibility (e.g., passing from using HARQ-ACK bundling to no-bundling), and backward compatibility (e.g., make use “Repetition number” field dynamically) with no need of performing an RRC reconfiguration, while can minimize the number of new DCI bits required to be added. Strategy Option 1 may control the status of the DCI fields to zero through a legacy flag (i.e., HARQ-ACK bundling flag).
Strategy Option 2: This solution may be intended to set several legacy DCI fields to zero bit from the moment the 14 HARQ processes feature is configured, which can minimize the required DCI increase to one new DCI bit. Nonetheless, for using any of the legacy DCI fields that are set to zero, it may be needed to perform an RRC reconfiguration.
Strategy Option 3: This can be seen as a trade-off solution since it may only set to zero a legacy DCI field (i.e., “HARQ-ACK delay field”) that is no meaningful for the feature, since it has been agreed not to use an independent DCI field for the “HARQ-ACK delay”. This option can keep untouched the other DCI fields (i.e., “Repetition number” and “HARQ-ACK bundling flag” fields) as to offer scheduling flexibility, and backward compatibility with no need of performing an RRC reconfiguration. For this option, 4 new DCI bits may be required.
Strategy Option 4: This solution may be intended to offer scheduling flexibility, and backward compatibility with no need of performing an RRC reconfiguration, while minimizes the number of new DCI bits required to be added. It may be similar to Strategy Option 1, except that instead of controlling the status of the DCI fields to zero through a legacy flag (i.e., HARQ-ACK bundling flag), Strategy Option 4 may add a brand-new flag which implies having to use 1 bit for it.

The Rel-17 objective on introducing “14-HARQ processes in DL, for HD-FDD Cat M1 UEs” has continued to be discussed in 3GPP. It has been agreed that the HARQ-ACK delay solution may be RRC configured to be either as per Alt-1 (which may use a similar principle as the already agreed PDSCH scheduling delay) or as per Alt-2 (which may use the same principle as in the baseline just including longer delay values).

Moreover, based on recent 3GPP agreements, a 7-bits joint encoding solution may be used for the PDSCH scheduling delay and the HARQ-ACK delay configured with Alt-1 as to have full-flexibility (108 states in total):
PDSCH scheduling delay: There may be 3 different expressions.
HARQ-ACK delay configured with “Alt-1”: There may be 12 values for “y” and 3 values for “z”.
The joint encoding solution for Alt-1 with full-flexibility requires: 12 (3)+12 (3)+12 (3)=108 states.
Total Number of bits in DCI: 7 bits.

In an embodiment, a 5-bits joint encoding solution may be used for the PDSCH scheduling delay and the HARQ-ACK delay configured with Alt-2e, which may allow to have more elements (i.e., delay values) composing the HARQ-ACK delay set(s) than the ones available in legacy since with 5-bits there up to 32 states available.

Therefore, for the joint-encoding of the PDSCH scheduling delay and the HARQ-ACK delay configured with either Alt-1 or Alt-2, what is left to be done is analyzing which existing DCI fields could potentially be set to zero as to do not have to increase the size of the DCI more than necessary.

According to exemplary embodiments of the present disclosure, there may be various strategy options as below to address an issue about which DCI field(s) could potentially be set to zero without impacting the backward compatibility and flexibility expected from the 14 HARQ processes feature.

### Strategy Option 1: Dynamically Controlled Method (Via a DCI Field) for Setting the Legacy DCI Fields to Zero.

In accordance with an exemplary embodiment, when the 14 HARQ processes feature is configured and the “HARQ-ACK bundling flag” is set to 1, some legacy DCI fields may be set to zero, e.g., including the “Repetition number” field and the “HARQ-ACK delay” field.

In accordance with an exemplary embodiment, if “ce-14harqProcess” is configured (which means the higher layer configures the 14 HARQ processes feature) and the “HARQ-ACK bundling flag” is set to 1, the “Repetition number” field and the “HARQ-ACK delay” field may be set to zero, and a new DCI field may be used for the joint-encoding of the PDSCH scheduling delay and the HARQ-ACK delay.
O-bits Repetition number field (i.e., 2 bits from this field may become available e.g., for joint-encoding purposes).
0-bits HARQ-ACK delay field (i.e., 3 bits from this field may become available e.g., for joint-encoding purposes).
New DCI field “PDSCH_Scheduling_Delay_&_HARQ-ACK_Delay” may become available.
   7-bits “PDSCH_Scheduling_Delay_&_HARQ-ACK_Delay” when Alt-1 is configured. In the case that 7 bits are required for the joint-encoding purposes, 5 bits from the legacy fields may be re-used, meaning that the DCI size may be increased by 2 bits (i.e. the newly added 2 bits).
   5-bits “PDSCH_Scheduling_Delay_&_HARQ-ACK_Delay” when Alt-2e is configured. In the case that 5 bits are required for the joint-encoding purposes, 5 bits from the legacy fields may be re-used.

In accordance with an exemplary embodiment, if “ce-14harqProcess” is configured and the “HARQ-ACK bundling flag” is set to 0, the “Repetition number” field and the “HARQ-ACK delay” field may be used as in legacy. In this case, the “Repetition number” field may be kept as the 2-bits Repetition number field, and the “HARQ-ACK delay” field may be kept as the 3-bits HARQ-ACK delay field. In an embodiment, for the newly added 2 bits in the new DCI field as described above, there may be the following two variants:
Variant 1:2 bits (newly added) may be utilized regardless of whether the DCI Format 6-1A changes in size depending on the configured joint-encoding solution. The 2 bits may be used to keep usable the PDSCH scheduling delays expression associated to the delay of 2, 7-type-1, and 7-type-2 with no bundling.
Variant 2:2 bits (newly added) required by Alt-1 may be reserved when the DCI Format 6-1A does not change in size regardless of the configured joint-encoding solution, or when the DCI Format 6-1A changes in size depending on the configured joint-encoding solution either 2-bits (newly added) required by Alt-1 are reserved or no new bits are required to be added when Alt-2e is configured. It is noted that with Variant 2, the legacy PDSCH scheduling delay of 2 BL/CE DL subframes may apply with no bundling.

It can be appreciated that in this document, for simplicity, the expression “7-type-1” and “7-type-2” may be used to represent the HARQ process whose PDSCH scheduling delay is any one of the two configurations:
7-type-1:1 BL/CE DL subframe+1 subframe+3 BL/CE UL subframes+1 subframe+1 BL/CE DL subframe.
7-type-2:1 subframe+3 BL/CE UL subframes+1 subframe+2 BL/CE DL subframes.

In accordance with an exemplary embodiment, if “ce-14harqProcess” is not configured, the “Repetition number” field and the “HARQ-ACK delay” field may be used as in legacy. In this case, the “Repetition number” field may be kept as a 2-bits field, and the “HARQ-ACK delay” field may be kept as a 3-bits field.

By using Strategy Option 1, the “Repetition number” field may be enabled/disabled through the status of the “HARQ-ACK bundling flag”, which may follow the legacy principle used by the “DCI subframe repetition number” field. Following the legacy principle can avoid having to perform an RRC reconfiguration for the purpose using the “Repetition number” field as in legacy. It can be appreciated that having “ce-14harqProcess” configured does not mean that 14 HARQ processes are always in use, but rather that up to 14 HARQ processes can be used. Moreover, with Variant 1 the scheduling delay expressions associated to the delay of 2, 7-type1, and 7-type2 can be used with and without HARQ-ACK bundling, whereas with Variant 2 the legacy PDSCH scheduling delay of 2 BL/CE DL subframes may apply with no bundling.

In accordance with an exemplary embodiment, the DCI size (e.g., the size of DCI Format 6-1A) for introducing 14 HARQ processes joint encoding of HARQ-ACK delay and PDSCH scheduling delay may be increased by 2 bits.

In accordance with an exemplary embodiment, setting one or more legacy DCI fields to zero may be controlled through the status of a legacy flag (e.g., the HARQ-ACK bundling flag, etc.). For example, when the HARQ-ACK bundling flag is set to 1, one or more legacy DCI fields may be set to zero.

### Strategy Option 2: Semi-Statically Controlled Method (Via RRC Configuration) for Setting the Legacy DCI Fields to Zero.

In accordance with an exemplary embodiment, when the 14 HARQ processes feature is configured, some legacy DCI fields may be set to zero, e.g., including the “Repetition number” field, the “HARQ-ACK delay” field and the “HARQ-ACK bundling flag” field.

In accordance with an exemplary embodiment, if “ce-14harqProcess” is configured, the “Repetition number” field, the “HARQ-ACK delay” field and the “HARQ-ACK bundling flag” field may be set to zero, and a new DCI field may be used for the joint-encoding of the PDSCH scheduling delay and the HARQ-ACK delay.
0-bits Repetition number field (i.e., 2 bits from this field may become available e.g., for joint-encoding purposes).
0-bits HARQ-ACK delay field (i.e., 3 bits from this field may become available e.g., for joint-encoding purposes).
0-bit HARQ-ACK bundling flag (i.e., 1 bit from this field may become available e.g., for joint-encoding purposes).
New DCI field “PDSCH_Scheduling_Delay_&_HARQ-ACK_Delay” may become available.
   7-bits “PDSCH_Scheduling_Delay_&_HARQ-ACK_Delay” when Alt-1 is configured. In the case that 7 bits are required for the joint-encoding purposes, 6 bits from the legacy fields may be re-used, meaning that the DCI size may be increased by 1 bit (i.e. the newly added 1 bit).
   5-bits “PDSCH_Scheduling_Delay_&_HARQ-ACK_Delay” when Alt-2e is configured. In the case that 5 bits are required for the joint-encoding purposes, 5 bits from the legacy fields may be re-used. In an embodiment, 2 bits (including 1 bit from a legacy field and the newly added 1 bit) required by Alt-1 may be reserved when the DCI Format 6-1A does not change in size when Alt-2e is configured (i.e., when the DCI size does not change regardless of the configured joint-encoding solution), or when Alt-2e is configured and the DCI Format 6-1A changes in size depending on the configured joint-encoding solution, no new bit is required to be added and only the 1 bit from a legacy field may be reserved. In another embodiment, when Alt-2e is configured, the 1 bit from a legacy field may continue being used as in legacy, e.g., the HARQ-ACK bundling flag.

In accordance with an exemplary embodiment, if “ce-14harqProcess” is not configured, the “Repetition number” field, the “HARQ-ACK delay” field and the “HARQ-ACK bundling flag” may be used as in legacy. In this case, the “Repetition number” field may be kept as a 2-bits field, the “HARQ-ACK delay” field may be kept as a 3-bits field, and the “HARQ-ACK bundling flag” may be kept as a 1-bit flag.

By using Strategy Option 2, the legacy use of the “Repetition number” field may remain unavailable if “ce-14harqProcess” is configured, and in order to enable it, it may be needed to perform an RRC reconfiguration. It may not be possible to switch between HARQ-ACK Bundling and No-Bundling if “ce-14harqProcess” is configured. In order to make use of No-Bundling, it may be required to perform an RRC reconfiguration.

In accordance with an exemplary embodiment, the DCI size (e.g., the size of DCI Format 6-1A) for introducing 14 HARQ processes joint encoding of HARQ-ACK delay and PDSCH scheduling delay may be increased by 1 bit.

### Strategy Option 3: Semi-Statically Controlled Method (Via RRC Configuration) for Setting the Legacy DCI Fields to Zero.

In accordance with an exemplary embodiment, when the 14 HARQ processes feature is configured, only the legacy “HARQ-ACK delay” DCI field may be set to zero.

In accordance with an exemplary embodiment, if “ce-14harqProcess” is configured, the “Repetition number” field and the “HARQ-ACK bundling flag” may be used as in legacy (i.e., the “Repetition number” field may be kept as a 2-bits field and the “HARQ-ACK bundling flag” may be kept as a 1-bit flag), while the “HARQ-ACK delay” field may be set to zero, and a new DCI field may be used for the joint-encoding of the PDSCH scheduling delay and the HARQ-ACK delay.
2-bits Repetition number field.
0-bits HARQ-ACK delay field (i.e., 3 bits from this field may become available e.g., for joint-encoding purposes).
1-bit HARQ-ACK bundling flag.
New DCI field “PDSCH_Scheduling_Delay_&_HARQ-ACK_Delay” may become available.
   7-bits “PDSCH_Scheduling_Delay_& HARQ-ACK_Delay” when Alt-1 is configured. In the case that 7 bits are required for the joint-encoding purposes, 3 bits from the legacy fields may be re-used, meaning that the DCI size may be increased by 4 bits (i.e. the newly added 4 bits).
   5-bits “PDSCH_Scheduling_Delay_&_HARQ-ACK_Delay” when Alt-2e is configured. In the case that 5 bits are required for the joint-encoding purposes, 3 bits from the legacy fields may be re-used, meaning that the DCI size may be increased by 2 bits (i.e. the newly added 2 bits). In an embodiment, the other 2 bits (newly added) additionally required by Alt-1 may be reserved when the DCI Format 6-1A does not change in size when Alt-2e is configured (i.e., when the DCI size does not change regardless of the configured jointly-encoding solution), or when Alt-2e is configured and the DCI Format 6-1A changes in size depending on the configured jointly-encoding solution, then only 2 bits are required to be added.

In accordance with an exemplary embodiment, if “ce-14harqProcess” is not configured, the “Repetition number” field, the “HARQ-ACK delay” field and the “HARQ-ACK bundling flag” may be used as in legacy. In this case, the “Repetition number” field may be kept as a 2-bits field, the “HARQ-ACK delay” field may be kept as a 3-bits field, and the “HARQ-ACK bundling flag” may be kept as a 1-bit flag.

By using Strategy Option 3, both the “Repetition number” and the “HARQ-ACK bundling flag” fields may be kept untouched as to allow using them as in legacy. Hence the delays schedulable through joint-encoding may be usable with and without HARQ-ACK bundling. That is, the repetition number DCI field and the HARQ-ACK delay DCI field remain unmodified and usable as prior to standardization support of 14 HARQ processes in downlink, DL when the 14 hybrid automatic repeat request, HARQ, processes feature is configured.

In accordance with an exemplary embodiment, the DCI size (e.g., the size of DCI Format 6-1A) for introducing 14 HARQ processes joint encoding of HARQ-ACK delay and PDSCH scheduling delay may be increased by 4 bits.

### Strategy Option 4: Dynamically Controlled Method (Via a DCI Field) for Setting the Legacy DCI Fields to Zero.

In accordance with an exemplary embodiment, a “New flag” may be introduced to enable the joint encoding of the HARQ-ACK delay and PDSCH scheduling delay. In an embodiment, when this “New flag” is set to 1, some legacy DCI fields may be set to zero, e.g., including the “Repetition number” field and the “HARQ-ACK delay” field.

In accordance with an exemplary embodiment, if “ce-14harqProcess” is configured and the “New flag” is set to 1, the “HARQ-ACK bundling flag” may be used as in legacy (i.e., the “HARQ-ACK bundling flag” may be kept as a 1-bit flag), while the “Repetition number” field and the “HARQ-ACK delay” field may be set to zero, and a new DCI field may be used for the joint-encoding of the PDSCH scheduling delay and the HARQ-ACK delay.
0-bits Repetition number field (i.e., 2 bits from this field may become available e.g., for joint-encoding purposes).
0-bits HARQ-ACK delay field (i.e., 3 bits from this field may become available e.g., for joint-encoding purposes).
1-bit HARQ-ACK bundling flag.
New DCI field “PDSCH_Scheduling_Delay_& HARQ-ACK_Delay” may become available.
   7-bits “PDSCH_Scheduling_Delay_&_HARQ-ACK_Delay” when Alt-1 is configured. In the case that 7 bits are required for the joint-encoding purposes, 5 bits from the legacy fields may be re-used, meaning that the DCI size may be increased by 2 bits (i.e. the newly added 2 bits) plus 1 bit of the “New flag”, i.e. 3 bits in total.
   5-bits “PDSCH_Scheduling_Delay_&_HARQ-ACK_Delay” when Alt-2e is configured. In the case that 5 bits are required for the joint-encoding purposes, 5 bits from the legacy fields may be re-used.

In accordance with an exemplary embodiment, if “ce-14harqProcess” is configured and the “New flag” is set to 0, the “Repetition number” field, the “HARQ-ACK delay” field and the “HARQ-ACK bundling flag” may be used as in legacy. In this case, the “Repetition number” field may be kept as a 2-bits field, the “HARQ-ACK delay” field may be kept as a 3-bits field, and the “HARQ-ACK bundling flag” may be kept as a 1-bit flag. In an embodiment, the newly added 2 bits required by Alt-1 may be reserved when the DCI Format 6-1A does not change in size regardless of the configured jointly-encoding solution, or when the DCI Format 6-1A changes in size depending on the configured jointly-encoding solution either 2 bits (newly added) required by Alt-1 are reserved or no new bits are required to be added when Alt-2e is configured. In an embodiment, the other 1 bit newly added for the “New flag” may not be reserved regardless of whether the DCI Format 6-1A changes in size depending on the configured jointly-encoding solution, since the “New flag” may be always used.

In accordance with an exemplary embodiment, if “ce-14harqProcess” is not configured, the “Repetition number” field, the “HARQ-ACK delay” field and the “HARQ-ACK bundling flag” may be used as in legacy. In this case, the “Repetition number” field may be kept as a 2-bits field, the “HARQ-ACK delay” field may be kept as a 3-bits field, and the “HARQ-ACK bundling flag” may be kept as a 1-bit flag.

By using Strategy Option 4, the “Repetition number” field may be enabled/disabled through the status of a “New flag”, which may follow the legacy principle (i.e., flag-based enabling/disabling) used by the “DCI subframe repetition number” field. This may avoid having to perform an RRC reconfiguration for the purpose using the “Repetition number” field as in legacy. Meanwhile, the “HARQ-ACK bundling flag” may be kept used as in legacy as to allow passing dynamically from using HARQ-ACK bundling to not using HARQ-ACK bundling.

In accordance with an exemplary embodiment, the DCI size (e.g., the size of DCI Format 6-1A) for introducing 14 HARQ processes joint encoding of HARQ-ACK delay and PDSCH scheduling delay may be increased by 3 bits.

In accordance with an exemplary embodiment, setting one or more legacy DCI fields to zero may be controlled through the status of a new DCI field playing the role of a new flag (e.g., 1-bit flag). For example, when the new flag is set to 1, one or more legacy DCI fields may be set to zero.

In accordance with an exemplary embodiment, setting one or more legacy DCI fields to zero being controlled through the status of a new DCI field playing the role of a new flag (e.g., 1-bit flag) may be applicable to any DCI design used for joint encoding of the HARQ-ACK delay and PDSCH scheduling delay as part of the 14 HARQ processes feature.

In accordance with an exemplary embodiment, various strategies such as Strategy Option 1, Strategy Option 2, Strategy Option 3 and Strategy Option 4 may be combined as to produce a hybrid strategy applicable to any DCI design used for joint encoding of the HARQ-ACK delay and PDSCH scheduling delay as part of the 14 HARQ processes feature.

In accordance with an exemplary embodiment, the legacy “Transport blocks in a bundle” field of which “2 bits indicate from 1 to 4 transport blocks in a bundle” may be used to mimic a No-Bundling if through such a field it is indicated “1 transport block in a bundle”. Mimicking no-Bundling through the legacy “Transport blocks in a bundle” field may be applicable to any DCI design used for joint encoding of the HARQ-ACK delay and the PDSCH scheduling delay as part of the 14 HARQ processes feature. Mimicking no-Bundling through the legacy “Transport blocks in a bundle” field may allow to set the “HARQ-ACK bundling flag” to zero bits.

In accordance with an exemplary embodiment, the legacy DCI fields that may be set to zero bits depending on the status of a flag and/or whether the 14 HARQ processes feature is configured, can change their location (i.e., the DCI fields can be in a different line) with respect to description of DCI fields in DCI Format 6-1A prior to Rel-17.

In accordance with an exemplary embodiment, the legacy DCI fields that may be set to zero bits can change their location (i.e., the DCI fields can be in a different line) with respect to the description of DCI fields in DCI Format 6-1A prior to Rel-17, so as to facilitate the implementation of new DCI fields (e.g., a new DCI field used to indicate the joint encoding of the PDSCH scheduling delay and HARQ-ACK delay) and/or to offer backward compatibility with respect to previous 3GPP releases.

In accordance with an exemplary embodiment, the joint-encoding solution configured via RRC signaling used to jointly indicate the “PDSCH Scheduling delay” and the “HARQ-ACK delay” can be based on solutions requiring a different number of bits for its implementation, where the DCI Format 6-1A may change in size depending on the configured jointly-encoding solution.

In accordance with an exemplary embodiment, the joint-encoding solution configured via RRC signaling used to jointly indicate the “PDSCH Scheduling delay” and “HARQ-ACK delay” can be based on solutions requiring a different number of bits for its implementation, where the DCI Format 6-1A may not change in size regardless of the configured jointly-encoding solution. In this case, the DCI size may take into account the largest required increase by the most bit-demanding jointly-encoding solution and the DCI size may be the same regardless of the jointly-encoding solution configured using RRC signaling.

It can be realized that various DCI fields such as the “Repetition number” field, the “HARQ-ACK delay” field and the “HARQ-ACK bundling flag” and configurations for different information elements and solutions such as 7-bits “PDSCH_Scheduling_Delay_&_HARQ-ACK_Delay” for Alt-1 and 5-bits “PDSCH_Scheduling_Delay_&_HARQ-ACK_Delay” for Alt-2e described herein + are just examples. Other information fields and parameter/solution configurations may also be applicable to implement various embodiments.

It is noted that some embodiments of the present disclosure are mainly described in relation to 4G/LTE or 5G/NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

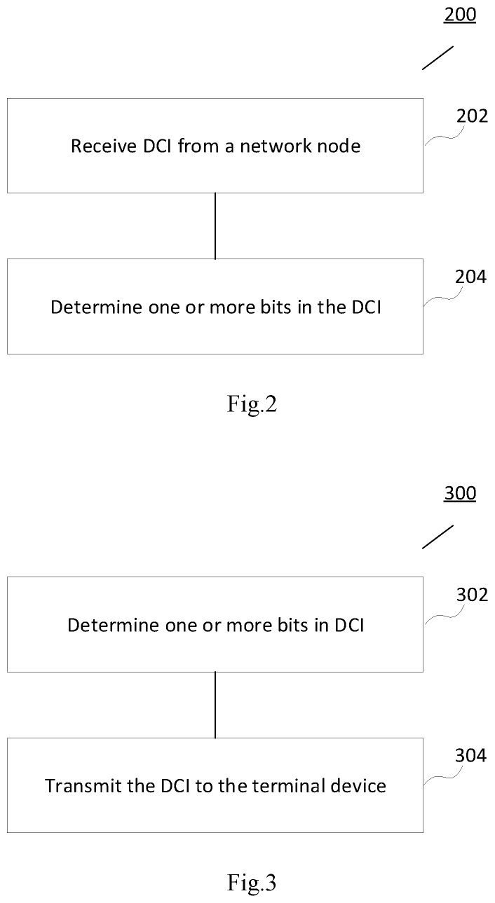

FIG. 2 is a flowchart illustrating a method 200 according to some embodiments of the present disclosure. The method 200 illustrated in FIG. 2 may be performed by a terminal device or an apparatus communicatively coupled to the terminal device. In accordance with an exemplary embodiment, the terminal device (e.g., a UE such as LTE-MTC UE) may be configured to communicate with a network node such as an eNB or a gNB via various communication protocols.

According to the exemplary method 200 illustrated in FIG. 2, the terminal device may receive DCI from a network node, as shown in block 202. In accordance with an exemplary embodiment, the terminal device may determine one or more bits in the DCI, as shown in block 204. The one or more bits in the DCI are determined for forming a joint encoding DCI field indicating both PDSCH scheduling delay and HARQ-ACK delay, based at least in part on a 14 HARQ processes feature being configured. In other words, the one or more bits in the DCI are determined to be available for building a joint-encoding DCI solution. In an embodiment, the one or more bits are associated to one or more DCI fields existing prior to the standardization support of 14 HARQ processes in DL (e.g., for LTE-MTC UEs). In another embodiment, the one or more bits are associated to only one DCI field existing prior to the standardization support of 14 HARQ processes in DL. The one or more bits in the DCI may be solely used or used along with one or more other bits for building a joint encoding DCI field indicating both PDSCH scheduling delay and HARQ-ACK delay, based at least in part on whether a 14 HARQ processes feature is configured or not, or on a DCI field playing a role of flag for enabling/disabling the joint encoding DCI field while the 14 HARQ processes feature is configured for the terminal device.

In accordance with an exemplary embodiment, when the one or more bits associated to the one or more existing DCI fields prior to the standardization support of 14 HARQ processes in DL are used along with the one or more other bits for building the joint encoding DCI field, a size of DCI Format 6-1A providing downlink scheduling information in the form of DCI fields may be increased by the one or more other bits with respect to a size of DCI Format 6-1A used prior to the standardization support of 14 HARQ processes in DL.

In accordance with an exemplary embodiment, DCI Format 6-1A may refer to a set of instructions used to provide the downlink scheduling information to the terminal device. DCI Format 6-1A may contain one or more DCI fields, which may comprise the instructions that the terminal device may get as the scheduling information.

In accordance with an exemplary embodiment, the one or more bits associated to the one or more existing DCI fields used for building the joint encoding DCI field indicating both the PDSCH scheduling delay and the HARQ-ACK delay may be from: a repetition number field, a HARQ-ACK delay field, and/or a HARQ-ACK bundling flag field, etc.

In accordance with an exemplary embodiment, when the 14 HARQ processes feature is configured for the terminal device and a predefined flag is set to 1, the one or more existing DCI fields prior to the support of 14 HARQ processes in DL may each be set to 0 bits, in such a way that the one or more bits associated to the one or more existing DCI fields may be available for joint encoding of the PDSCH scheduling delay and the HARQ-ACK delay.

In accordance with an exemplary embodiment, the one or more bits associated to the one or more existing DCI fields used for building the joint encoding DCI field indicating both the PDSCH scheduling delay and the HARQ-ACK delay may comprise:
2 bits from a repetition number field (in an embodiment, when the 2 bits become available for the joint encoding of the PDSCH scheduling delay and the HARQ-ACK delay, the repetition number field may be disabled, e.g., the repetition number field may be set to be a 0-bit field and considered as inexistent meanwhile); and
3 bits from a HARQ-ACK delay field (in an embodiment, when the 3 bits become available for the joint encoding of the PDSCH scheduling delay and the HARQ-ACK delay, the HARQ-ACK delay field may be disabled, e.g., the HARQ-ACK delay field may be set to be a 0-bit field and considered as inexistent meanwhile).

In accordance with an exemplary embodiment, when the number of the one or more bits associated to the one or more existing DCI fields available for the joint encoding of the PDSCH scheduling delay and the HARQ-ACK delay is less than the number of bits required to jointly indicate the PDSCH scheduling delay and the HARQ-ACK delay, the joint encoding DCI field may include the one or more other bits in addition to the one or more bits associated to the one or more existing DCI fields prior to the support of 14 HARQ processes in DL.

In accordance with an exemplary embodiment, the one or more other bits may comprise 2 bits. For example, 2 brand new bits may be added into the joint encoding DCI field, together with 5 bits from existing DCI fields (e.g., 2 bits from the repetition number field and 3 bits from the HARQ-ACK delay field), so as to build-up the 7-bits based joint-encoding solution.

In accordance with an exemplary embodiment, when the one or more bits associated to the one or more existing DCI fields prior to the support of 14 HARQ processes in DL are unavailable for the joint encoding of the PDSCH scheduling delay and the HARQ-ACK delay, the one or more other bits may be reserved or reused, e.g., for other purposes such as indicating in an unjointed manner or solely the PDSCH scheduling delay.

In accordance with an exemplary embodiment, when the 14 HARQ processes feature is configured for the terminal device and a predefined flag is set to 0, the one or more bits associated to the one or more existing DCI fields prior to the support of 14 HARQ processes in DL may be unavailable for joint encoding of the PDSCH scheduling delay and the HARQ-ACK delay.

In accordance with an exemplary embodiment, the predefined flag may be a HARQ-ACK bundling flag in an existing DCI field prior to the support of 14 HARQ processes in DL. In accordance with another exemplary embodiment, the predefined flag may be a flag in a newly added field.

In accordance with an exemplary embodiment, when the 14 HARQ processes feature is configured for the terminal device, the one or more bits associated to the one or more existing DCI fields prior to the support of 14 HARQ processes in DL may be available for joint encoding of the PDSCH scheduling delay and the HARQ-ACK delay.

In accordance with an exemplary embodiment, the one or more bits associated to the existing DCI fields used for building the joint encoding DCI field indicating both the PDSCH scheduling delay and the HARQ-ACK delay may comprise one or more of:

2 bits from a repetition number field (in an embodiment, when the 2 bits become available for the joint encoding of the PDSCH scheduling delay and the HARQ-ACK delay, the repetition number field may be disabled, e.g., the repetition number field may be set to be a 0-bit field and considered as inexistent meanwhile); and 3 bits from a HARQ-ACK delay field (in an embodiment, when the 3 bits become available for the joint encoding of the PDSCH scheduling delay and the HARQ-ACK delay, the HARQ-ACK delay field may be disabled, e.g., the HARQ-ACK delay field may be set to be a 0-bit field and considered as inexistent meanwhile).

1 bit from a HARQ-ACK bundling flag field (in an embodiment, when the 1 bit become available for the joint encoding of the PDSCH scheduling delay and the HARQ-ACK delay, the HARQ-ACK bundling flag field may be disabled, e.g., the HARQ-ACK bundling flag field may be set to be a 0-bit field and considered as inexistent meanwhile).

In accordance with an exemplary embodiment, when the number of the one or more bits associated to the one or more existing DCI fields available for the joint encoding of the PDSCH scheduling delay and the HARQ-ACK delay is less than the number of bits required to jointly indicate the PDSCH scheduling delay and the HARQ-ACK delay, the joint encoding DCI field may include the one or more other bits in addition to the one or more bits associated to the one or more DCI fields existing prior to the standard support of 14 HARQ processes in DL.

In accordance with an exemplary embodiment, the one or more other bits may comprise 1 bit. For example, 1 brand new bit may be added into the joint encoding DCI field, together with 6 bits from existing DCI fields (e.g., 2 bits from the repetition number field, 3 bits from the HARQ-ACK delay field, and 1 bit from the HARQ-ACK bundling flag field), so as to build-up the 7-bits based joint-encoding solution.

In accordance with an exemplary embodiment, the one or more other bits may comprise 4 bits. For example, 4 brand new bits may be added into the joint encoding DCI field, together with 3 bits from existing DCI fields (e.g., 3 bits from the HARQ-ACK delay field), so as to build-up the 7-bits based joint-encoding solution.

In accordance with an exemplary embodiment, the one or more other bits may comprise 2 bits. For example, 2 brand new bits may be added into the joint encoding DCI field, together with 3 bits from existing DCI fields (e.g., 3 bits from the HARQ-ACK delay field), so as to build-up the 5-bits based joint-encoding solution.

In accordance with an exemplary embodiment, when the size of DCI Format 6-1A providing downlink scheduling information in the form of a number DCI fields is larger than the number of bits required for the downlink scheduling information in case of configuration of a solution (e.g., 7-bits based joint-encoding solution or 5-bits based joint-encoding solution, etc.) used to jointly indicate the PDSCH scheduling delay and the HARQ-ACK delay, one or more bits which are unused to jointly indicate the PDSCH scheduling delay and the HARQ-ACK delay may be reserved or reused, e.g., for other purposes such as indicating in an unjointed manner or solely the PDSCH scheduling delay.

In accordance with an exemplary embodiment, the size of DCI format 6-1A providing the downlink scheduling information may change as a function of the solution used to jointly indicate the PDSCH scheduling delay and the HARQ-ACK delay. In an embodiment, the solution used to jointly indicate the PDSCH scheduling delay and the HARQ-ACK delay may consist of either 5 bits or 7 bits.

In accordance with an exemplary embodiment, when the 14 HARQ processes feature is not configured for the terminal device, the joint encoding DCI field may be unavailable. In this case, the size of DCI Format 6-1A may not be increased, and the one or more existing DCI fields may be available as prior to the support of 14 HARQ processes in DL.

In accordance with an exemplary embodiment, the PDSCH scheduling delay may be expressed in terms of different subframe types as follows:
2 BL/CE DL subframes;
1 BL/CE DL subframe+1 subframe+3 BL/CE UL subframes+1 subframe+1 BL/CE DL subframe; or
1 subframe+3 BL/CE UL subframes+1 subframe+2 BL/CE DL subframes.

In accordance with an exemplary embodiment, the HARQ-ACK delay may be expressed in terms of different subframes types as follows:
(y) BL/CE DL subframe+1 subframe+ (z) BL/CE UL subframes, where y={0, 1, 2, . . . 11} and z={1, 2, 3}.

In accordance with an exemplary embodiment, the HARQ-ACK delay may be expressed in terms of absolute subframes using integer values.

FIG. 3 is a flowchart illustrating a method 300 according to some embodiments of the present disclosure. The method 300 illustrated in FIG. 3 may be performed by a network node or an apparatus communicatively coupled to the network node. In accordance with an exemplary embodiment, the network node may comprise a base station such as an eNB or a gNB. The network node may be configured to communicate with one or more terminal devices such as UEs via various communication protocols.

According to the exemplary method 300 illustrated in FIG. 3, the network node may determine one or more bits in DCI, as shown in block 302. The one or more bits in DCI are determined for forming a joint encoding DCI field indicating both PDSCH scheduling delay and HARQ-ACK delay, based at least in part on a 14 HARQ processes feature being configured. In other words, the one or more bits in the DCI are determined to be available for building a joint-encoding DCI solution. In an embodiment, the one or more bits are associated to one or more DCI fields existing prior to the standardization support of 14 HARQ processes in DL (e.g., for LTE-MTC UEs), In another embodiment, the one or more bits are associated with only one DCI field existing prior to standardization support of 14 HARQ processes in DL. The one or more bits in the DCI may be solely used or used along with one or more other bits for building a joint encoding DCI field indicating both PDSCH scheduling delay and HARQ-ACK delay, based at least in part on whether a 14 HARQ processes feature is configured or not, or on a DCI field playing a role of flag for enabling/disabling the joint encoding DCI field while the 14 HARQ processes feature is configured for the terminal device. In accordance with an exemplary embodiment, the network node may transmit the DCI to the terminal device, as shown in block 304.

It can be appreciated that the steps, operations and related configurations according to the method 300 illustrated in FIG. 3 may correspond to the steps, operations and related configurations according to the method 200 illustrated in FIG. 2. It also can be appreciated that the DCI transmitted by the network node according to the method 300 may correspond to the DCI received by the terminal device according to the method 200. Thus, the DCI as described with respect to FIG. 2 and FIG. 3 may have the same or similar contents and/or feature elements. Correspondingly, the one or more bits and optionally the one or more other bits included in the joint encoding DCI field as described with respect to FIG. 2 and FIG. 3 may have the same or similar contents and/or feature elements and may be configured in a same or similar manner.

The various blocks shown in FIGS. 2-3 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

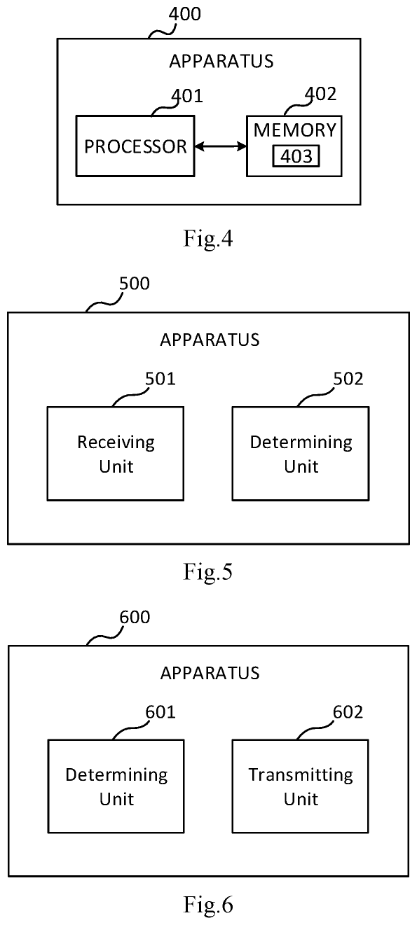

FIG. 4 is a block diagram illustrating an apparatus 400 according to various embodiments of the present disclosure. As shown in FIG. 4, the apparatus 400 may comprise one or more processors such as processor 401 and one or more memories such as memory 402 storing computer program codes 403. The memory 402 may be non-transitory machine/processor/computer readable storage medium. In accordance with some exemplary embodiments, the apparatus 400 may be implemented as an integrated circuit chip or module that can be plugged or installed into a terminal device as described with respect to FIG. 2, or a network node as described with respect to FIG. 3. In such case, the apparatus 400 may be implemented as a terminal device as described with respect to FIG. 2, or a network node as described with respect to FIG. 3.

In some implementations, the one or more memories 402 and the computer program codes 403 may be configured to, with the one or more processors 401, cause the apparatus 400 at least to perform any operation of the method as described in connection with FIG. 2. In other implementations, the one or more memories 402 and the computer program codes 403 may be configured to, with the one or more processors 401, cause the apparatus 400 at least to perform any operation of the method as described in connection with FIG. 3. Alternatively or additionally, the one or more memories 402 and the computer program codes 403 may be configured to, with the one or more processors 401, cause the apparatus 400 at least to perform more or less operations to implement the proposed methods according to the exemplary embodiments of the present disclosure.

FIG. 5 is a block diagram illustrating an apparatus 500 according to some embodiments of the present disclosure. As shown in FIG. 5, the apparatus 500 may comprise a receiving unit 501 and a determining unit 502. In an exemplary embodiment, the apparatus 500 may be implemented in a terminal device such as a UE. The receiving unit 501 may be operable to carry out the operation in block 202, and the determining unit 502 may be operable to carry out the operation in block 204. Optionally, the receiving unit 501 and/or the determining unit 502 may be operable to carry out more or less operations to implement the proposed methods according to the exemplary embodiments of the present disclosure.

FIG. 6 is a block diagram illustrating an apparatus 600 according to some embodiments of the present disclosure. As shown in FIG. 6, the apparatus 600 may comprise a determining unit 601 and a transmitting unit 602. In an exemplary embodiment, the apparatus 600 may be implemented in a network node such as a base station. The determining unit 601 may be operable to carry out the operation in block 302, and the transmitting unit 602 may be operable to carry out the operation in block 304. Optionally, the determining unit 601 and/or the transmitting unit 602 may be operable to carry out more or less operations to implement the proposed methods according to the exemplary embodiments of the present disclosure.

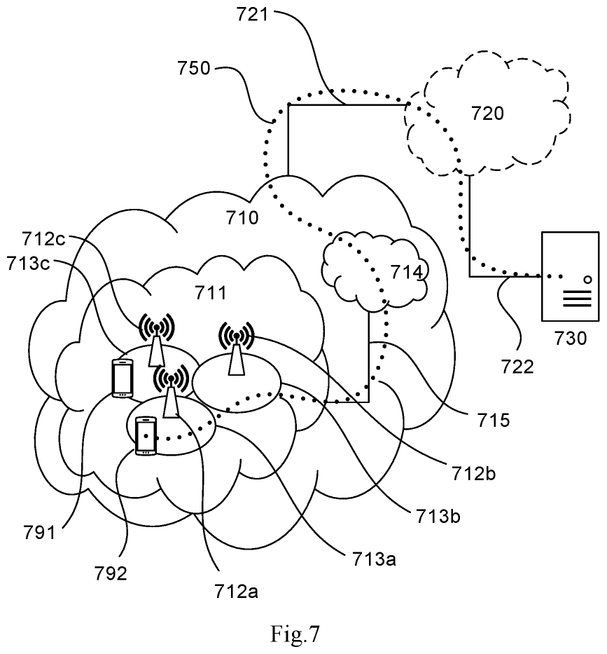

FIG. 7 is a block diagram illustrating a telecommunication network connected via an intermediate network to a host computer in accordance with some embodiments of the present disclosure.

With reference to FIG. 7, in accordance with an embodiment, a communication system includes a telecommunication network 710, such as a 3GPP-type cellular network, which comprises an access network 711, such as a radio access network, and a core network 714. The access network 711 comprises a plurality of base stations 712a, 712b, 712c, such as NBs, eNBs, gNBs or other types of wireless access points, each defining a corresponding coverage area 713a, 713b, 713c. Each base station 712a, 712b, 712c is connectable to the core network 714 over a wired or wireless connection 715. A first UE 791 located in a coverage area 713c is configured to wirelessly connect to, or be paged by, the corresponding base station 712c. A second UE 792 in a coverage area 713a is wirelessly connectable to the corresponding base station 712a. While a plurality of UEs 791, 792 are illustrated in this example, the disclosed embodiments are equally applicable to a situation where a sole UE is in the coverage area or where a sole UE is connecting to the corresponding base station 712.

The telecommunication network 710 is itself connected to a host computer 730, which may be embodied in the hardware and/or software of a standalone server, a cloud-implemented server, a distributed server or as processing resources in a server farm. The host computer 730 may be under the ownership or control of a service provider, or may be operated by the service provider or on behalf of the service provider. Connections 721 and 722 between the telecommunication network 710 and the host computer 730 may extend directly from the core network 714 to the host computer 730 or may go via an optional intermediate network 720. An intermediate network 720 may be one of, or a combination of more than one of, a public, private or hosted network; the intermediate network 720, if any, may be a backbone network or the Internet; in particular, the intermediate network 720 may comprise two or more sub-networks (not shown).

The communication system of FIG. 7 as a whole enables connectivity between the connected UEs 791, 792 and the host computer 730. The connectivity may be described as an over-the-top (OTT) connection 750. The host computer 730 and the connected UEs 791, 792 are configured to communicate data and/or signaling via the OTT connection 750, using the access network 711, the core network 714, any intermediate network 720 and possible further infrastructure (not shown) as intermediaries. The OTT connection 750 may be transparent in the sense that the participating communication devices through which the OTT connection 750 passes are unaware of routing of uplink and downlink communications. For example, the base station 712 may not or need not be informed about the past routing of an incoming downlink communication with data originating from the host computer 730 to be forwarded (e.g., handed over) to a connected UE 791. Similarly, the base station 712 need not be aware of the future routing of an outgoing uplink communication originating from the UE 791 towards the host computer 730.

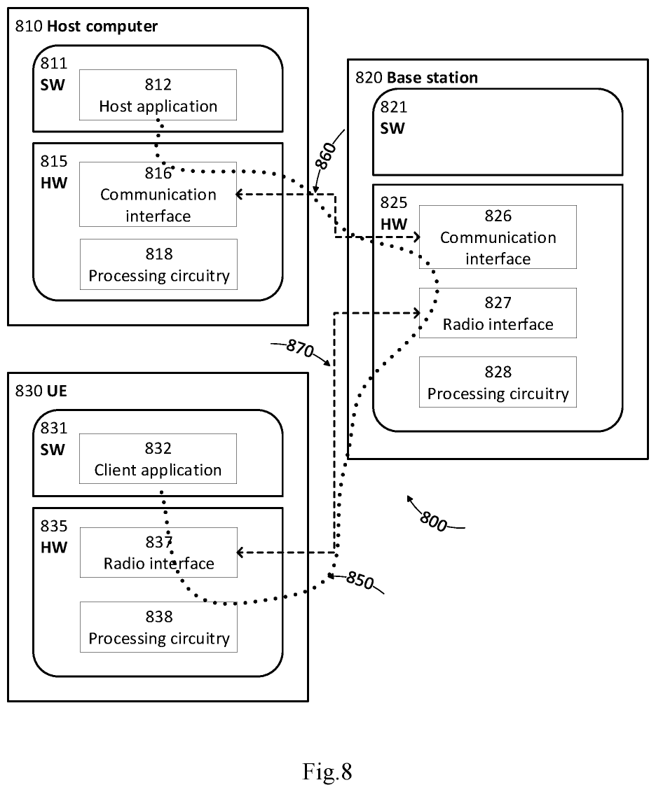

FIG. 8 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 8. In a communication system 800, a host computer 810 comprises hardware 815 including a communication interface 816 configured to set up and maintain a wired or wireless connection with an interface of a different communication device of the communication system 800. The host computer 810 further comprises a processing circuitry 818, which may have storage and/or processing capabilities. In particular, the processing circuitry 818 may comprise one or more programmable processors, application-specific integrated circuits, field programmable gate arrays or combinations of these (not shown) adapted to execute instructions. The host computer 810 further comprises software 811, which is stored in or accessible by the host computer 810 and executable by the processing circuitry 818. The software 811 includes a host application 812. The host application 812 may be operable to provide a service to a remote user, such as UE 830 connecting via an OTT connection 850 terminating at the UE 830 and the host computer 810. In providing the service to the remote user, the host application 812 may provide user data which is transmitted using the OTT connection 850.

The communication system 800 further includes a base station 820 provided in a telecommunication system and comprising hardware 825 enabling it to communicate with the host computer 810 and with the UE 830. The hardware 825 may include a communication interface 826 for setting up and maintaining a wired or wireless connection with an interface of a different communication device of the communication system 800, as well as a radio interface 827 for setting up and maintaining at least a wireless connection 870 with the UE 830 located in a coverage area (not shown in FIG. 8) served by the base station 820. The communication interface 826 may be configured to facilitate a connection 860 to the host computer 810. The connection 860 may be direct or it may pass through a core network (not shown in FIG. 8) of the telecommunication system and/or through one or more intermediate networks outside the telecommunication system. In the embodiment shown, the hardware 825 of the base station 820 further includes a processing circuitry 828, which may comprise one or more programmable processors, application-specific integrated circuits, field programmable gate arrays or combinations of these (not shown) adapted to execute instructions. The base station 820 further has software 821 stored internally or accessible via an external connection.

The communication system 800 further includes the UE 830 already referred to. Its hardware 835 may include a radio interface 837 configured to set up and maintain a wireless connection 870 with a base station serving a coverage area in which the UE 830 is currently located. The hardware 835 of the UE 830 further includes a processing circuitry 838, which may comprise one or more programmable processors, application-specific integrated circuits, field programmable gate arrays or combinations of these (not shown) adapted to execute instructions. The UE 830 further comprises software 831, which is stored in or accessible by the UE 830 and executable by the processing circuitry 838. The software 831 includes a client application 832. The client application 832 may be operable to provide a service to a human or non-human user via the UE 830, with the support of the host computer 810. In the host computer 810, an executing host application 812 may communicate with the executing client application 832 via the OTT connection 850 terminating at the UE 830 and the host computer 810. In providing the service to the user, the client application 832 may receive request data from the host application 812 and provide user data in response to the request data. The OTT connection 850 may transfer both the request data and the user data. The client application 832 may interact with the user to generate the user data that it provides.

It is noted that the host computer 810, the base station 820 and the UE 830 illustrated in FIG. 8 may be similar or identical to the host computer 730, one of base stations 712a, 712b, 712c and one of UEs 791, 792 of FIG. 7, respectively. This is to say, the inner workings of these entities may be as shown in FIG. 8 and independently, the surrounding network topology may be that of FIG. 7.

In FIG. 8, the OTT connection 850 has been drawn abstractly to illustrate the communication between the host computer 810 and the UE 830 via the base station 820, without explicit reference to any intermediary devices and the precise routing of messages via these devices. Network infrastructure may determine the routing, which it may be configured to hide from the UE 830 or from the service provider operating the host computer 810, or both. While the OTT connection 850 is active, the network infrastructure may further take decisions by which it dynamically changes the routing (e.g., on the basis of load balancing consideration or reconfiguration of the network).

Wireless connection 870 between the UE 830 and the base station 820 is in accordance with the teachings of the embodiments described throughout this disclosure. One or more of the various embodiments improve the performance of OTT services provided to the UE 830 using the OTT connection 850, in which the wireless connection 870 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 850 between the host computer 810 and the UE 830, in response to variations in the measurement results. The measurement procedure and/or the network functionality for reconfiguring the OTT connection 850 may be implemented in software 811 and hardware 815 of the host computer 810 or in software 831 and hardware 835 of the UE 830, or both. In embodiments, sensors (not shown) may be deployed in or in association with communication devices through which the OTT connection 850 passes; the sensors may participate in the measurement procedure by supplying values of the monitored quantities exemplified above, or supplying values of other physical quantities from which the software 811, 831 may compute or estimate the monitored quantities. The reconfiguring of the OTT connection 850 may include message format, retransmission settings, preferred routing etc.; the reconfiguring need not affect the base station 820, and it may be unknown or imperceptible to the base station 820. Such procedures and functionalities may be known and practiced in the art. In certain embodiments, measurements may involve proprietary UE signaling facilitating the host computer 810's measurements of throughput, propagation times, latency and the like. The measurements may be implemented in that the software 811 and 831 causes messages to be transmitted, in particular empty or ‘dummy’ messages, using the OTT connection 850 while it monitors propagation times, errors etc.

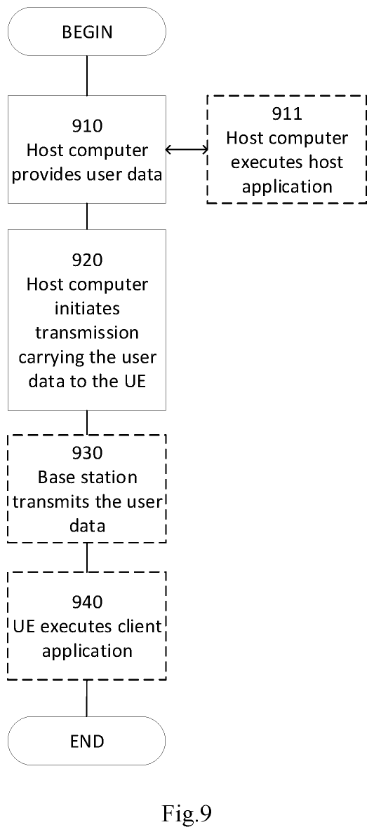

FIG. 9 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 9 will be included in this section. In step 910, the host computer provides user data. In substep 911 (which may be optional) of step 910, the host computer provides the user data by executing a host application. In step 920, the host computer initiates a transmission carrying the user data to the UE. In step 930 (which may be optional), the base station transmits to the UE the user data which was carried in the transmission that the host computer initiated, in accordance with the teachings of the embodiments described throughout this disclosure. In step 940 (which may also be optional), the UE executes a client application associated with the host application executed by the host computer.

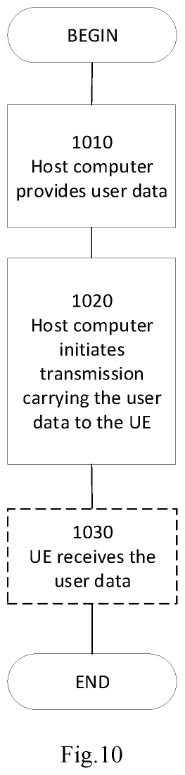

FIG. 10 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 10 will be included in this section. In step 1010 of the method, the host computer provides user data. In an optional substep (not shown) the host computer provides the user data by executing a host application. In step 1020, the host computer initiates a transmission carrying the user data to the UE. The transmission may pass via the base station, in accordance with the teachings of the embodiments described throughout this disclosure. In step 1030 (which may be optional), the UE receives the user data carried in the transmission.

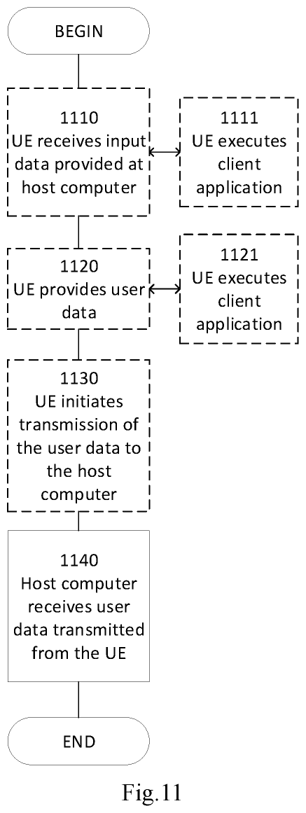

FIG. 11 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 11 will be included in this section. In step 1110 (which may be optional), the UE receives input data provided by the host computer. Additionally or alternatively, in step 1120, the UE provides user data. In substep 1121 (which may be optional) of step 1120, the UE provides the user data by executing a client application. In substep 1111 (which may be optional) of step 1110, the UE executes a client application which provides the user data in reaction to the received input data provided by the host computer. In providing the user data, the executed client application may further consider user input received from the user. Regardless of the specific manner in which the user data was provided, the UE initiates, in substep 1130 (which may be optional), transmission of the user data to the host computer. In step 1140 of the method, the host computer receives the user data transmitted from the UE, in accordance with the teachings of the embodiments described throughout this disclosure.

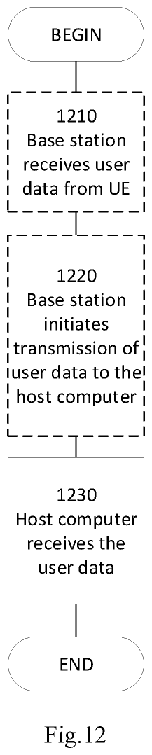

FIG. 12 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 12 will be included in this section. In step 1210 (which may be optional), in accordance with the teachings of the embodiments described throughout this disclosure, the base station receives user data from the UE. In step 1220 (which may be optional), the base station initiates transmission of the received user data to the host computer. In step 1230 (which may be optional), the host computer receives the user data carried in the transmission initiated by the base station.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the exemplary method 300 as describe with respect to FIG. 3.

According to some exemplary embodiments, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the exemplary method 300 as describe with respect to FIG. 3.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the exemplary method 200 as describe with respect to FIG. 2.

According to some exemplary embodiments, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the exemplary method 200 as describe with respect to FIG. 2.

According to some exemplary embodiments, there is provided a method implemented in a communication system which may include a host computer, a base station and a UE. The method may comprise, at the host computer, receiving user data transmitted to the base station from the UE which may perform any step of the exemplary method 200 as describe with respect to FIG. 2.

According to some exemplary embodiments, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the exemplary method 200 as describe with respect to FIG. 2.

According to some exemplary embodiments, there is provided a method implemented in a communication system which may include a host computer, a base station and a UE. The method may comprise, at the host computer, receiving, from the base station, user data originating from a transmission which the base station has received from the UE. The base station may perform any step of the exemplary method 300 as describe with respect to FIG. 3.

According to some exemplary embodiments, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the exemplary method 300 as describe with respect to FIG. 3.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

### Examples

Example 1. A method (200) performed by a terminal device, comprising:
   receiving (202) downlink control information, DCI, from a network node, determining (204) one or more bits in the DCI, wherein the one or more bits are associated to one or more existing DCI fields prior the support of 14 hybrid automatic repeat request, HARQ, processes in downlink, DL, and are solely used or used along with one or more other bits for building a joint encoding DCI field indicating both physical downlink shared channel, PDSCH, scheduling delay and hybrid automatic repeat request-acknowledgement, HARQ-ACK, delay, based at least in part on whether a 14 HARQ processes feature is configured or not, or on a DCI field playing a role of flag for enabling/disabling the joint encoding DCI field while the 14 HARQ processes feature is configured for the terminal device.
Example 2. The method according to Example 1, wherein when the one or more bits associated to the one or more existing DCI fields are used along with the one or more other bits for building the joint encoding DCI field, a size of DCI format 6-1A providing downlink scheduling information in the form of DCI fields is increased by the one or more other bits with respect to a size of DCI format 6-1A used prior the support of 14 HARQ processes in DL.
Example 3. The method according to Example 1 or 2, wherein the one or more bits associated to the one or more existing DCI fields used for building the joint encoding DCI field indicating both the PDSCH scheduling delay and the HARQ-ACK delay are from one or more of the following fields:
   a repetition number field;
   a HARQ-ACK delay field; and
   a HARQ-ACK bundling flag field.
Example 4. The method according to any of Examples 1-3, wherein when the 14 HARQ processes feature is configured for the terminal device and a predefined flag is set to 1, the one or more existing DCI fields prior the support of 14 HARQ processes in DL are each set to 0 bits, in such a way that the one or more bits associated to the one or more existing DCI fields are available for joint encoding of the PDSCH scheduling delay and the HARQ-ACK delay.
Example 5. The method according to Example 4, wherein the one or more bits associated to the one or more existing DCI fields used for building the joint encoding DCI field indicating both the PDSCH scheduling delay and the HARQ-ACK delay comprise one or more of:
   2 bits from a repetition number field; and
   3 bits from a HARQ-ACK delay field.
Example 6. The method according to Example 4 or 5, wherein when a number of the one or more bits associated to the one or more existing DCI fields available for the joint encoding of the PDSCH scheduling delay and the HARQ-ACK delay is less than a number of bits required to jointly indicate the PDSCH scheduling delay and the HARQ-ACK delay, the joint encoding DCI field includes the one or more other bits in addition to the one or more bits associated to the one or more existing DCI fields prior the support of 14 HARQ processes in DL.
Example 7. The method according to Example 6, wherein the one or more other bits comprise 2 bits.
Example 8. The method according to Example 6 or 7, wherein when the one or more bits associated to the one or more existing DCI fields prior the support of 14 HARQ processes in DL are unavailable for the joint encoding of the PDSCH scheduling delay and the HARQ-ACK delay, the one or more other bits are reserved or reused for indicating in an unjointed manner or solely the PDSCH scheduling delay.
Example 9. The method according to any of Examples 1-8, wherein when the 14 HARQ processes feature is configured for the terminal device and a predefined flag is set to 0, the one or more bits associated to the one or more existing DCI fields prior the support of 14 HARQ processes in DL are unavailable for joint encoding of the PDSCH scheduling delay and the HARQ-ACK delay.
Example 10. The method according to any of Examples 4-9, wherein the predefined flag is:
   a HARQ-ACK bundling flag in an existing DCI field prior the support of 14 HARQ processes in DL; or
   a flag in a newly added field.
Example 11. The method according to any of Examples 1-3, wherein when the 14 HARQ processes feature is configured for the terminal device, the one or more bits associated to the one or more existing DCI fields prior the support of 14 HARQ processes in DL are available for joint encoding of the PDSCH scheduling delay and the HARQ-ACK delay.
Example 12. The method according to Example 11, wherein the one or more bits associated to the existing DCI fields used for building the joint encoding DCI field indicating both the PDSCH scheduling delay and the HARQ-ACK delay comprise one or more of:
   2 bits from a repetition number field;
   3 bits from a HARQ-ACK delay field; and
   1 bit from a HARQ-ACK bundling flag field.
Example 13. The method according to Example 11 or 12, wherein when a number of the one or more bits associated to the one or more existing DCI fields available for the joint encoding of the PDSCH scheduling delay and the HARQ-ACK delay is less than a number of bits required to jointly indicate the PDSCH scheduling delay and the HARQ-ACK delay, the joint encoding DCI field includes the one or more other bits in addition to the one or more bits associated to the one or more existing DCI fields prior the support of 14 HARQ processes in DL.
Example 14. The method according to Example 13, wherein the one or more other bits comprise 1 bit.
Example 15. The method according to Example 13, wherein the one or more other bits comprise 4 bits.
Example 16. The method according to Example 13, wherein the one or more other bits comprise 2 bits.
Example 17. The method according to any of Examples 1-16, wherein when a size of DCI format 6-1A providing downlink scheduling information in the form of a number DCI fields is larger than a number of bits required for the downlink scheduling information in case of configuration of a solution used to jointly indicate the PDSCH scheduling delay and the HARQ-ACK delay, one or more bits which are unused to jointly indicate the PDSCH scheduling delay and the HARQ-ACK delay are reserved or reused for indicating in an unjointed manner or solely the PDSCH scheduling delay.
Example 18. The method according to Example 17, wherein the size of DCI format 6-1A providing the downlink scheduling information changes as a function of the solution used to jointly indicate the PDSCH scheduling delay and the HARQ-ACK delay; and wherein the solution used to jointly indicate the PDSCH scheduling delay and the HARQ-ACK delay consists of either 5 bits or 7 bits.
Example 19. The method according to any of Examples 1-18, wherein when the 14 HARQ processes feature is not configured for the terminal device, the joint encoding DCI field is unavailable, a size of DCI format 6-1A is not increased, and the one or more existing DCI fields are available as prior the support of 14 HARQ processes in DL.
Example 20. The method according to any of Examples 1-19, wherein the PDSCH scheduling delay is expressed in terms of different subframe types as follows:
   2 bandwidth-reduced low-complexity or coverage enhanced downlink, BL/CE DL, subframes;
   1 BL/CE DL subframe+1 subframe+3 BL/CE uplink, UL, subframes+1 subframe+1 BL/CE DL subframe; or
   1 subframe+3 BL/CE UL subframes+1 subframe+2 BL/CE DL subframes.
Example 21. The method according to any of Examples 1-20, wherein the HARQ-ACK delay is expressed in terms of different subframes types as follows:
   (y) BL/CE DL subframe+1 subframe+ (z) BL/CE UL subframes, where y={0, 1, 2, . . . 11} and z={1, 2, 3}.
Example 22. The method according to any of Examples 1-20, wherein the HARQ-ACK delay is expressed in terms of absolute subframes using integer values.
Example 23. The method according to any of Examples 1-22, wherein the terminal device is a long term evolution-machine type communication, LTE-MTC, user equipment, UE.
Example 24. A terminal device (400), comprising:
   one or more processors (401); and
   one or more memories (402) comprising computer program codes (403),
   the one or more memories (402) and the computer program codes (403) configured to, with the one or more processors (401), cause the terminal device (400) at least to:
   receive downlink control information, DCI, from a network node,
   determine one or more bits in the DCI, wherein the one or more bits are associated to one or more existing DCI fields prior the support of 14 hybrid automatic repeat request, HARQ, processes in downlink, DL, and are solely used or used along with one or more other bits for building a joint encoding DCI field indicating both physical downlink shared channel, PDSCH, scheduling delay and hybrid automatic repeat request-acknowledgement, HARQ-ACK, delay, based at least in part on whether a 14 HARQ processes feature is configured or not, or on a DCI field playing a role of flag for enabling/disabling the joint encoding DCI field while the 14 HARQ processes feature is configured for the terminal device.
Example 25. The terminal device according to Example 24, wherein the one or more memories and the computer program codes are configured to, with the one or more processors, cause the terminal device to perform the method according to any one of Examples 2-23.
Example 26. A computer-readable medium having computer program codes (403) embodied thereon which, when executed on a computer, cause the computer to perform any step of the method according to any one of Examples 1-23.
Example 27. A method (300) performed by a network node, comprising:
   determining (302) one or more bits in downlink control information, DCI, wherein the one or more bits are associated to one or more existing DCI fields prior the support of 14 hybrid automatic repeat request, HARQ, processes in downlink, DL, and are solely used or used along with one or more other bits for building a joint encoding DCI field indicating both physical downlink shared channel, PDSCH, scheduling delay and hybrid automatic repeat request-acknowledgement, HARQ-ACK, delay, based at least in part on whether a 14 HARQ processes feature is configured or not, or on a DCI field playing a role of flag for enabling/disabling the joint encoding DCI field while the 14 HARQ processes feature is configured for a terminal device; and
   transmitting (304) the DCI to the terminal device.
Example 28. The method according to Example 27, wherein when the one or more bits associated to the one or more existing DCI fields are used along with the one or more other bits for building the joint encoding DCI field, a size of DCI format 6-1A providing downlink scheduling information in the form of DCI fields is increased by the one or more other bits with respect to a size of DCI format 6-1A used prior the support of 14 HARQ processes in DL.
Example 29. The method according to Example 27 or 28, wherein the one or more bits associated to the one or more existing DCI fields used for building the joint encoding DCI field indicating both the PDSCH scheduling delay and the HARQ-ACK delay are from one or more of the following fields:
   a repetition number field;
   a HARQ-ACK delay field; and
   a HARQ-ACK bundling flag field.
Example 30. The method according to any of Examples 27-29, wherein when the 14 HARQ processes feature is configured for the terminal device and a predefined flag is set to 1, the one or more existing DCI fields prior the support of 14 HARQ processes in DL are each set to 0 bits, in such a way that the one or more bits associated to the one or more existing DCI fields are available for joint encoding of the PDSCH scheduling delay and the HARQ-ACK delay.
Example 31. The method according to Example 30, wherein the one or more bits associated to the one or more existing DCI fields used for building the joint encoding DCI field indicating both the PDSCH scheduling delay and the HARQ-ACK delay comprise one or more of:
   2 bits from a repetition number field; and
   3 bits from a HARQ-ACK delay field.
Example 32. The method according to Example 30 or 31, wherein when a number of the one or more bits associated to the one or more existing DCI fields available for the joint encoding of the PDSCH scheduling delay and the HARQ-ACK delay is less than a number of bits required to jointly indicate the PDSCH scheduling delay and the HARQ-ACK delay, the joint encoding DCI field includes the one or more other bits in addition to the one or more bits associated to the one or more existing DCI fields prior the support of 14 HARQ processes in DL.
Example 33. The method according to Example 32, wherein the one or more other bits comprise 2 bits.
Example 34. The method according to Example 32 or 33, wherein when the one or more bits associated to the one or more existing DCI fields prior the support of 14 HARQ processes in DL are unavailable for the joint encoding of the PDSCH scheduling delay and the HARQ-ACK delay, the one or more other bits are reserved or reused for indicating in an unjointed manner or solely the PDSCH scheduling delay.
Example 35. The method according to any of Examples 27-34, wherein when the 14 HARQ processes feature is configured for the terminal device and a predefined flag is set to 0, the one or more bits associated to the one or more existing DCI fields prior the support of 14 HARQ processes in DL are unavailable for joint encoding of the PDSCH scheduling delay and the HARQ-ACK delay.
Example 36. The method according to any of Examples 30-35, wherein the predefined flag is:
   a HARQ-ACK bundling flag in an existing DCI field prior the support of 14 HARQ processes in DL; or
   a flag in a newly added field.
Example 37. The method according to any of Examples 27-29, wherein when the 14 HARQ processes feature is configured for the terminal device, the one or more bits associated to the one or more existing DCI fields prior the support of 14 HARQ processes in DL are available for joint encoding of the PDSCH scheduling delay and the HARQ-ACK delay.
Example 38. The method according to Example 37, wherein the one or more bits associated to the existing DCI fields used for building the joint encoding DCI field indicating both the PDSCH scheduling delay and the HARQ-ACK delay comprise one or more of:
   2 bits from a repetition number field;
   3 bits from a HARQ-ACK delay field; and
   1 bit from a HARQ-ACK bundling flag field.
Example 39. The method according to Example 37 or 38, wherein when a number of the one or more bits associated to the one or more existing DCI fields available for the joint encoding of the PDSCH scheduling delay and the HARQ-ACK delay is less than a number of bits required to jointly indicate the PDSCH scheduling delay and the HARQ-ACK delay, the joint encoding DCI field includes the one or more other bits in addition to the one or more bits associated to the one or more existing DCI fields prior the support of 14 HARQ processes in DL.
Example 40. The method according to Example 39, wherein the one or more other bits comprise 1 bit.
Example 41. The method according to Example 39, wherein the one or more other bits comprise 4 bits.
Example 42. The method according to Example 39, wherein the one or more other bits comprise 2 bits.
Example 43. The method according to any of Examples 27-42, wherein when a size of DCI format 6-1A providing downlink scheduling information in the form of a number DCI fields is larger than a number of bits required for the downlink scheduling information in case of configuration of a solution used to jointly indicate the PDSCH scheduling delay and the HARQ-ACK delay, one or more bits which are unused to jointly indicate the PDSCH scheduling delay and the HARQ-ACK delay are reserved or reused for indicating in an unjointed manner or solely the PDSCH scheduling delay.
Example 44. The method according to Example 43, wherein the size of DCI format 6-1A providing the downlink scheduling information changes as a function of the solution used to jointly indicate the PDSCH scheduling delay and the HARQ-ACK delay; and wherein the solution used to jointly indicate the PDSCH scheduling delay and the HARQ-ACK delay consists of either 5 bits or 7 bits.
Example 45. The method according to any of Examples 27-44, wherein when the 14 HARQ processes feature is not configured for the terminal device, the joint encoding DCI field is unavailable, a size of DCI format 6-1A is not increased, and the one or more existing DCI fields are available as prior the support of 14 HARQ processes in DL.
Example 46. The method according to any of Examples 27-45, wherein the PDSCH scheduling delay is expressed in terms of different subframe types as follows:
   2 bandwidth-reduced low-complexity or coverage enhanced downlink, BL/CE DL, subframes;
   1 BL/CE DL subframe+1 subframe+3 BL/CE uplink, UL, subframes+1 subframe+1 BL/CE DL subframe; or
   1 subframe+3 BL/CE UL subframes+1 subframe+2 BL/CE DL subframes.
Example 47. The method according to any of Examples 27-46, wherein the HARQ-ACK delay is expressed in terms of different subframes types as follows:
   (y) BL/CE DL subframe+1 subframe+ (z) BL/CE UL subframes, where y={0, 1, 2, . . . 11} and z={1, 2, 3}.
Example 48. The method according to any of Examples 27-46, wherein the HARQ-ACK delay is expressed in terms of absolute subframes using integer values.
Example 49. The method according to any of Examples 27-48, wherein the terminal device is a long term evolution-machine type communication, LTE-MTC, user equipment, UE.
Example 50. A network node (400), comprising:
   one or more processors (401); and
   one or more memories (402) comprising computer program codes (403),
   the one or more memories (402) and the computer program codes (403) configured to, with the one or more processors (401), cause the network node (400) at least to:
   determine one or more bits in downlink control information, DCI, wherein the one or more bits are associated to one or more existing DCI fields prior the support of 14 hybrid automatic repeat request, HARQ, processes in downlink, DL, and are solely used or used along with one or more other bits for building a joint encoding DCI field indicating both physical downlink shared channel, PDSCH, scheduling delay and hybrid automatic repeat request-acknowledgement, HARQ-ACK, delay, based at least in part on whether a 14 HARQ processes feature is configured or not, or on a DCI field playing a role of flag for enabling/disabling the joint encoding DCI field while the 14 HARQ processes feature is configured for a terminal device; and transmit the DCI to the terminal device.
Example 51. The network node according to Example 50, wherein the one or more memories and the computer program codes are configured to, with the one or more processors, cause the network node to perform the method according to any one of Examples 28-49.
Example 52. A computer-readable medium having computer program codes (403) embodied thereon which, when executed on a computer, cause the computer to perform any step of the method according to any one of Examples 27-49.

1-18. (canceled)

19. A method performed by a terminal device for handling downlink control information, comprising:
receiving downlink control information (DCI) from a network node; and
determining one or more bits in the DCI available for forming a joint encoding DCI field indicating both physical downlink shared channel (PDSCH) scheduling delay and hybrid automatic repeat request-acknowledgement, (HARQ-ACK) delay, based at least in part on a 14 hybrid automatic repeat request (HARQ) processes feature being configured;
wherein the one or more bits are associated with only one DCI field existing prior to standardization support of the 14 HARQ processes feature in downlink (DL).

20. The method of claim 19, wherein the one or more bits in the DCI comprise 3 bits from a HARQ-ACK delay field.

21. The method of claim 19, wherein when a total number of the one or more bits in the DCI is less than a number of bits required to jointly indicate the PDSCH scheduling delay and the HARQ-ACK delay, the joint encoding DCI field includes one or more other bits in addition to the one or more bits in the DCI.

22. The method of claim 21, wherein the one or more other bits comprises 4 bits.

23. The method of claim 21, wherein the one or more other bits comprises 2 bits.

24. The method of claim 19, wherein the terminal device is a long-term evolution-machine type communication (LTE-MTC) user equipment (UE).

25. A terminal device, comprising:
processing circuitry and memory, the memory storing instructions executable by the processing circuitry whereby the terminal device is configured to:
receive downlink control information (DCI) from a network node; and
determine one or more bits in the DCI available for forming a joint encoding DCI field indicating both physical downlink shared channel (PDSCH) scheduling delay and hybrid automatic repeat request-acknowledgement (HARQ-ACK) delay, based at least in part on a 14 hybrid automatic repeat request (HARQ) processes feature being configured;
wherein the one or more bits are associated with only one DCI field existing prior to standardization support of the 14 HARQ processes feature in downlink (DL).

26. The terminal device of claim 25, wherein the one or more bits in the DCI comprise 3 bits from a HARQ-ACK delay field.

27. The terminal device of claim 25, wherein when a total number of the one or more bits in the DCI is less than a number of bits required to jointly indicate the PDSCH scheduling delay and the HARQ-ACK delay, the joint encoding DCI field includes one or more other bits in addition to the one or more bits in the DCI.

28. The terminal device of claim 27, wherein the one or more other bits comprises 4 bits.

29. The terminal device of claim 27, wherein the one or more other bits comprises 2 bits.

30. The terminal device of claim 25, wherein the terminal device is a long-term evolution-machine type communication (LTE-MTC) user equipment (UE).

31. A method performed by a network node for handling downlink control information, comprising:
determining one or more bits in downlink control information (DCI) available for forming a joint encoding DCI field indicating both physical downlink shared channel (PDSCH) scheduling delay and hybrid automatic repeat request-acknowledgement (HARQ-ACK) delay based at least in part on a 14 hybrid automatic repeat request (HARQ) processes feature being configured;
wherein the one or more bits are associated with only one DCI field existing prior to standardization support of the 14 HARQ processes feature in downlink (DL); and
transmitting the DCI to a terminal device.

32. The method of claim 31, wherein the one or more bits in the DCI comprise 3 bits from a HARQ-ACK delay field.

33. The method of claim 31, wherein when a total number of the one or more bits in the DCI is less than a number of bits required to jointly indicate the PDSCH scheduling delay and the HARQ-ACK delay, the joint encoding DCI field includes one or more other bits in addition to the one or more bits in the DCI.

34. The method of claim 33, wherein the one or more other bits comprises 4 bits.

35. The method of claim 33, wherein the one or more other bits comprises 2 bits.

36. A network node, comprising:
processing circuitry and memory, the memory storing instructions executable by the processing circuitry whereby the network node is configured to:
determine one or more bits in downlink control information (DCI) available for forming a joint encoding DCI field indicating both physical downlink shared channel (PDSCH) scheduling delay and hybrid automatic repeat request-acknowledgement (HARQ-ACK) delay, based at least in part on a 14 hybrid automatic repeat request (HARQ) processes feature being configured;
wherein the one or more bits are associated with only one DCI field existing prior to standardization support of the 14 HARQ processes feature in downlink (DL); and
transmit the DCI to a terminal device.

37. The network node of claim 36, wherein the one or more bits in the DCI comprise 3 bits from a HARQ-ACK delay field.

38. The network node of claim 36, wherein when a total number of the one or more bits in the DCI is less than a number of bits required to jointly indicate the PDSCH scheduling delay and the HARQ-ACK delay, the joint encoding DCI field includes one or more other bits in addition to the one or more bits in the DCI.

39. The network node of claim 38, wherein the one or more other bits comprises 4 bits.

40. The network node of claim 38, wherein the one or more other bits comprises 2 bits.

41. A non-transitory computer readable medium storing a computer program for controlling a terminal device, the computer program comprising software instructions that, when run on the terminal device, cause the terminal device to:
receive downlink control information (DCI) from a network node; and
determine one or more bits in the DCI available for forming a joint encoding DCI field indicating both physical downlink shared channel (PDSCH) scheduling delay and hybrid automatic repeat request-acknowledgement (HARQ-ACK) delay, based at least in part on a 14 hybrid automatic repeat request (HARQ) processes feature being configured;
wherein the one or more bits are associated with only one DCI field existing prior to standardization support of the 14 HARQ processes feature in downlink (DL).

42. A non-transitory computer readable medium storing a computer program codes for controlling a network node, the computer program codes comprising software instructions that, when run on the network node, cause the network node to:
determine one or more bits in downlink control information (DCI) available for forming a joint encoding DCI field indicating both physical downlink shared channel (PDSCH) scheduling delay and hybrid automatic repeat request-acknowledgement (HARQ-ACK) delay, based at least in part on a 14 hybrid automatic repeat request (HARQ) processes feature being configured;
wherein the one or more bits are associated with only one DCI field existing prior to standardization support of the 14 HARQ processes feature in downlink (DL); and
transmit the DCI to a terminal device.
